(19) United States
(12) Patent Application Publication
(10) Pub. No.: US 2014/0118332 A1
(43) Pub. Date: May 1, 2014

(54) METHOD OF DRIVING ACTIVE BARRIER PANEL AND DISPLAY APPARATUS FOR PERFORMING THE METHOD

(71) Applicant: Samsung Display Co., Ltd., Yongin-City (KR)

(72) Inventors: KWAN-HO KIM, Yongin-si (KR); Sang-Min Jeon, Yongin-si (KR); Jae-Woo Jung, Cheonan-si (KR); Goro Hamagishi, Hwaseong-si (KR); Seon-Ki Kim, Anyang-si (KR); Jin-Hwan Kim, Suwon-si (KR)

(21) Appl. No.: 13/914,806

(22) Filed: Jun. 11, 2013

(30) Foreign Application Priority Data
Oct. 29, 2012 (KR) 10-2012-0120116

(51) Int. Cl. G09G 5/14

(52) U.S. Cl. CPC G09G 5/14
USPC 345/214

(57) ABSTRACT

A method of driving an active barrier panel, the active barrier panel comprising an electrode unit which has n barrier electrodes operating as an opening part transmitting light and n barrier electrodes operating as a barrier part blocking the light, the method includes calculating a crosstalk distribution of each of observer's left-eye and right-eye corresponding to each of 2n barrier-shift modes, according to an observer's position, dividing an active area of the active barrier panel into at least one barrier block based on a flat portion of the crosstalk distribution, in which a minimum crosstalk is maintained, determining the barrier-shift mode for each barrier block to maintain the minimum crosstalk, and operating the electrode unit in a corresponding barrier block in the determined barrier-shift mode.

This application claims priority to Korean Patent Application No. 10-2012-0120116, filed on Oct. 29, 2012, the disclosure of which is incorporated by reference in its entirety herein.

### BACKGROUND 1. Technical Field

Exemplary embodiments of the present invention relate to a method of driving an active barrier panel and a display apparatus for performing the method. More particularly, exemplary embodiments of the present invention relate to a method of driving an active barrier panel capable of extending an optimum view distance (“OVD”) and a display apparatus for performing the method.

2. Discussion of Related Art

Liquid crystal display apparatuses typically display two dimensional planar images. However, there is a need to display three dimensional stereoscopic images in various industry fields, such as game, movie, etc. Accordingly, liquid crystal display apparatuses that can display three dimensional stereoscopic images are being developed.

Three-dimensional (“3D”) stereoscopic images may be displayed using a principle of binocular parallax through human eyes. For example, images observed from different angles through each eye are input to the human brain of a viewer because human eyes are spaced apart a certain distance. A stereoscopic image displaying apparatus uses the principle of binocular parallax to enable an observer to perceive 2D images as 3D images.

There are two methods of displaying three-dimensional images using the binocular parallax: stereoscopic types (“glasses types”) and autostereoscopic types (“no-glasses types”). The stereoscopic method, which employs glasses, may use either polarization glasses or shutter glasses. The auto-stereoscopic method, which is done without glasses, may employ lenticular lenses, a barrier, liquid crystal lenses, a liquid crystal barrier, etc.

A portable display apparatus may be configured to display the 3D stereoscopic image. The portable display apparatus is typically used with a no-glasses type of three-dimensional display, rather than the glasses type of three dimensional display, which requires glasses.

### BRIEF SUMMARY

Exemplary embodiments of the present invention provide a method of driving an active barrier panel, which may extend an optimum viewing distance of an observer.

Exemplary embodiments of the present invention provide a display apparatus for performing the method of driving an active barrier panel.

According to an exemplary embodiment of the invention, there is provided a method of driving an active barrier panel, the active barrier panel comprising an electrode unit which has n barrier electrodes operating as an opening part transmitting light and n barrier electrodes operating as a barrier part blocking the light, the method including calculating a crosstalk distribution of each of observer's left-eye and right-eye corresponding to each of 2n barrier-shift modes, according to an observer's position, dividing an active area of the active barrier panel into at least one barrier block based on a flat portion of the crosstalk distribution, in which a minimum crosstalk is maintained, determining the barrier-shift mode for each barrier block to maintain the minimum crosstalk, and operating the electrode unit in a corresponding barrier block in the determined barrier-shift mode.

In an exemplary embodiment, the dividing the active area may include determining a central portion between a first end portion of the flat portion in a right-eye crosstalk distribution and a second end portion of the flat portion in a left-eye crosstalk distribution, as a boundary of the barrier block, when an observer's view distance is outside an optimum view distance (“OVD”), the observer' view distance being a straight distance between an observer's position and the active barrier panel.

In an exemplary embodiment, when the observer' view distance is less than the OVD, a central portion between a first end portion of the flat portion in a right-eye crosstalk distribution corresponding to an N-th barrier-shift mode and a second end portion of the flat portion in a left-eye crosstalk distribution corresponding to an (N−1)-th barrier-shift mode, may be determined as a boundary of the barrier block, wherein the N-th barrier-shift mode includes the barrier part shifted toward a first side by one barrier electrode with respect to the barrier part of the (N−1)-th barrier-shift mode.

In an exemplary embodiment, when the observer' view distance is more than the OVD, a central portion between a first end portion of the flat portion in a right-eye crosstalk distribution corresponding to the N-th barrier-shift mode and a second end portion of the flat portion in a left-eye crosstalk distribution corresponding to an (N+1)-th barrier-shift mode, may be determined as a boundary of the barrier block, wherein the (N+1)-th barrier-shift mode includes the barrier part shifted toward the first side by one barrier electrode with respect to the barrier part of the N-th barrier-shift mode.

In an exemplary embodiment, when the observer' view distance is less than the OVD, the barrier blocks which are arranged in a preceding direction from the first side to a second side, may be respectively operated as the barrier-shift modes including the barrier parts sequentially shifted toward the second side by one barrier electrode.

In an exemplary embodiment, when the observer' view distance is more than the OVD, the barrier blocks which are arranged in a preceding direction from the first side to the second side, may be respectively operated as the barrier-shift modes including the barrier parts sequentially shifted toward the first side by one barrier electrode.

In an exemplary embodiment, a viewing area may be defined by a first end portion of the flat portion in a right-eye crosstalk distribution and a second end portion of the flat portion in a left-eye crosstalk distribution, and when the number of the barrier electrodes in the electrode unit is increased, the viewing area may be increased.

In an exemplary embodiment, a width of the electrode unit may be less than the viewing area.

In an exemplary embodiment, a width of the electrode unit may correspond to a period of a sub-pixel displaying the left-eye image or the right-eye image.

In an exemplary embodiment, the method may further include shifting the boundary of the barrier block according to the observer's position, when the observer's position is shifted in a horizontal direction.

In an exemplary embodiment, the n may be equal to or greater than six.

According to an exemplary embodiment of the invention, there is provided a display apparatus including a display panel including a plurality of sub-pixels, an active barrier panel disposed adjacent the display panel and including an electrode unit which includes n barrier electrodes operating as an opening part transmitting light and n barrier electrodes operating as a barrier part blocking the light, and a barrier control part calculating a crosstalk distribution of each of observer's left-eye and right-eye corresponding to each of 2n barrier-shift modes, according to an observer's position, dividing an active area of the active barrier panel into at least one barrier block based on a flat portion of the crosstalk distribution, in which a minimum crosstalk is maintained, and determining the barrier-shift mode for each barrier block to maintain the minimum crosstalk.

In an exemplary embodiment, the barrier control part may determine a central portion between a first end portion of the flat portion in a right-eye crosstalk distribution and a second end portion of the flat portion in a left-eye crosstalk distribution, as a boundary of the barrier block, when an observer's view distance is outside an optimum view distance (“OVD”), the observer' view distance is a straight distance between an observer's position and the active barrier panel.

In an exemplary embodiment, when the observer' view distance is less than the OVD, the barrier control part may determine a central portion between a first end portion of the flat portion in a right-eye crosstalk distribution corresponding to an N-th barrier-shift mode and a second end portion of the flat portion in a left-eye crosstalk distribution corresponding to an (N−1)-th barrier-shift mode, as a boundary of the barrier block, wherein the N-th barrier-shift mode includes the barrier part shifted toward a first side by one barrier electrode with respect to the barrier part of the (N−1)-th barrier-shift mode.

In an exemplary embodiment, when the observer' view distance is more than the OVD, the barrier control part may determine a central portion between a first end portion of the flat portion in a right-eye crosstalk distribution corresponding to the N-th barrier-shift mode and a second end portion of the flat portion in a left-eye crosstalk distribution corresponding to an (N+1)-th barrier-shift mode, as a boundary of the barrier block, wherein the (N+1)-th barrier-shift mode includes the barrier part shifted toward the first side by one barrier electrode with respect to the barrier part of the N-th barrier-shift mode.

In an exemplary embodiment, when the observer' view distance is less than the OVD, the barrier blocks which are arranged in a preceding direction from the first side to a second side, may be respectively operated as the barrier-shift modes including the barrier parts sequentially shifted toward the second side by one barrier electrode.

In an exemplary embodiment, when the observer' view distance is greater than the OVD, the barrier blocks which are arranged in a preceding direction from the first side to the second side, may be respectively operated as the barrier-shift modes including the barrier parts sequentially shifted toward the first side by one barrier electrode.

In an exemplary embodiment, when the number of the barrier electrodes in the electrode unit is increased, the viewing area is increased.

In an exemplary embodiment, a width of the electrode unit is less than the viewing area.

In an exemplary embodiment, a width of the electrode unit corresponds a period of a sub-pixel displaying the left-eye image or the right-eye image.

In an exemplary embodiment, when width of the electrode unit corresponds to two sub-pixels, a first sub-pixel may display the left-eye image and a second sub-pixel adjacent the first sub-pixel in a horizontal direction may display the right-eye image.

In an exemplary embodiment, when the observer's position is shifted in a horizontal direction, the barrier control part may shift the boundary of the barrier block in the horizontal direction according to the observer's position.

In an exemplary embodiment, the n may be equal to or greater than six.

In an exemplary embodiment, the active barrier panel includes a plurality of driving units, each of the driving units includes at least one electrode unit, and the barrier electrodes in the driving unit are driven together.

In an exemplary embodiment, during a first sub frame, first and second sub-pixels of the display panel may respectively display a left-eye image and a right-eye image and the barrier block of the active barrier panel may operate as the opening part and the barrier part based on the determined barrier-shift mode, and during a second sub frame, the first and second sub-pixels of the display panel may respectively display images opposite to those displayed on the first and second sub-pixels during the first sub frame, and the barrier block of the active barrier panel may operate as the opening part and the barrier part opposite to those operated during the first sub frame.

According to an exemplary embodiment of the invention, a display apparatus includes a display panel, an active barrier panel, a control part, and a barrier control part. The display panel includes plurality of pixels, where each pixel includes a pair of sub-pixels. The active barrier panel is disposed adjacent the display panel and includes ‘n’ barrier electrodes configured to operate as an opening part to transmit light and ‘n’ barrier electrodes configured to operate as a barrier part to block the light. The control part is configured to generate a signal indicating an observer distance an observer is located away from the active barrier panel. The barrier control part is configured to predict a left-eye and right-eye crosstalk distribution that would be experienced by the observer moving horizontally along the distance for each of 2n barrier-shift modes, divide the active barrier panel into barrier blocks, and drive each barrier block according to a selected one of the barrier-shift modes that provides a minimum corresponding crosstalk based on the predicted crosstalk distributions.

In an exemplary embodiment, the crosstalk is the minimum in flat portions of the left-eye and right-eye crosstalk distribution for one of the barrier-shift modes. In an exemplary embodiment, a boundary of one of the barrier blocks is a central portion between a first end portion of the flat portion in the right-eye crosstalk distribution of the one barrier-shift mode and a second end portion of the flat portion in the left-eye crosstalk distribution of the one barrier-shift mode.

According to at least one exemplary embodiment of the present invention, the barrier block of the active barrier panel and the barrier-shift mode corresponding to the barrier block are determined according to the observer's position, for example, the view distance with respect to the OVD and the active barrier panel is driven using the barrier-shift mode. Therefore, the flat portion in the left-eye and right-eye crosstalk distributions may be maintained so that the observer's optimum view distance is extended.

### BRIEF DESCRIPTION OF THE DRAWINGS

The present invention will become more apparent by describing in detail exemplary embodiments thereof with reference to the accompanying drawings, in which:

FIG. 1 is a block diagram illustrating a display apparatus according to an exemplary embodiment of the invention;

FIG. 2 is a conceptual diagram illustrating an exemplary position of an observer with respect to the display apparatus as shown in FIG. 1;

FIG. 3 is a plan view illustrating an active barrier panel shown in FIG. 1 according to an exemplary embodiment of the invention;

FIG. 4 is a plan view illustrating a driving unit shown in FIG. 1 according to an exemplary embodiment of the invention;

FIG. 5 is a conceptual diagram illustrating an electrode unit included in the active barrier panel shown in FIG. 1 according to an exemplary embodiment of the invention;

FIG. 6 is a conceptual diagram illustrating a plurality of exemplary barrier-shift modes of the electrode unit shown in FIG. 5;

FIG. 7 is a conceptual diagram illustrating an electrode unit included in the active barrier panel shown in FIG. 1 according to an exemplary embodiment of the invention;

FIG. 8 is a conceptual diagram illustrating a plurality of exemplary barrier-shift modes of the electrode unit shown in FIG. 7;

FIGS. 9A, 9B and 9C are conceptual diagrams illustrating a barrier control part, when an view distance (e.g., a straight distance) between the observer and the display apparatus, is less than the OVD;

FIG. 10 is a conceptual diagram illustrating a method of driving the active barrier panel by the barrier control part shown in FIGS. 9A, 9B and 9C according to an exemplary embodiment of the invention;

FIG. 11 is a conceptual diagram illustrating a left-eye crosstalk being observed by an observer's left-eye, when the observer moves toward a left-side at the view distance;

FIG. 12 is a conceptual diagram illustrating a method of driving the active barrier panel according to an exemplary embodiment of the invention for reducing the left-eye crosstalk shown in FIG. 11;

FIG. 13 is a conceptual diagram illustrating a right-eye crosstalk being observed by an observer's right-eye, when the observer moves toward a right-side at the view distance;

FIG. 14 is a conceptual diagram illustrating a method of driving the active barrier panel according to an exemplary embodiment of the invention for reducing the left-eye crosstalk shown in FIG. 13;

FIGS. 15A and 15B are conceptual diagrams illustrating a correlation between a width of the electrode unit and a viewing area;

FIG. 16 is a conceptual diagrams illustrating a barrier control part, when an view distance between the observer and the display apparatus, is more than the OVD; and

FIG. 17 is a conceptual diagram illustrating a method of driving the active barrier panel by the barrier control part shown in FIG. 16 according to an exemplary embodiment of the invention.

### DETAILED DESCRIPTION

Hereinafter, exemplary embodiments of the present invention will be explained in detail with reference to the accompanying drawings.

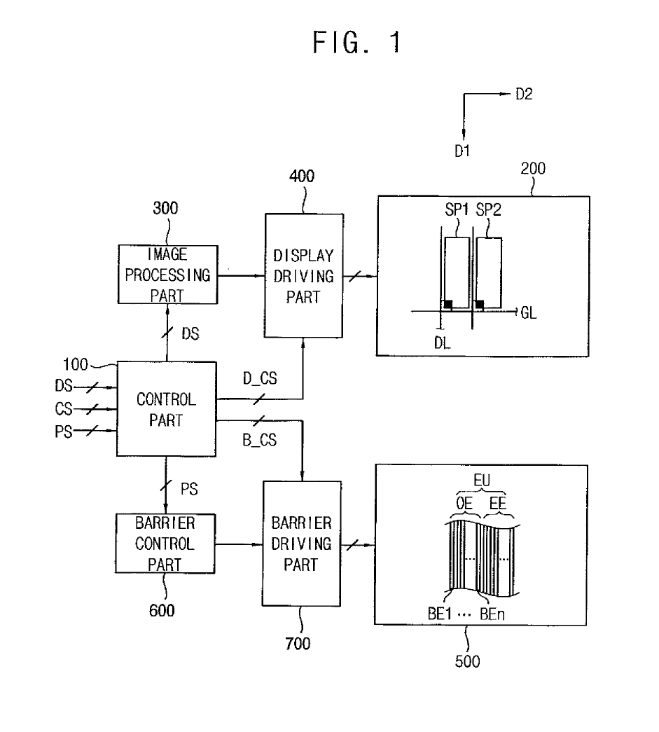

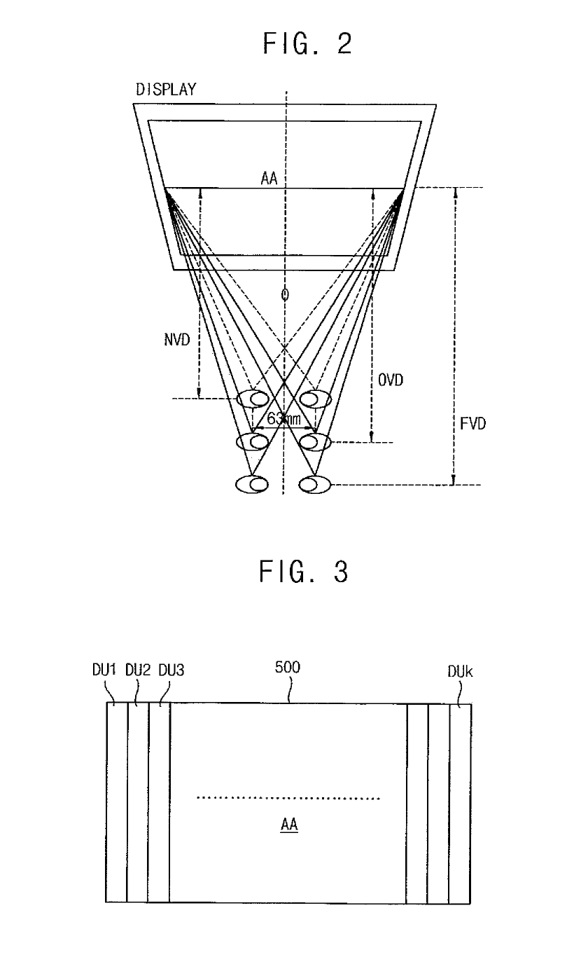

FIG. 1 is a block diagram illustrating a display apparatus according to an exemplary embodiment of the invention. FIG. 2 is a conceptual diagram illustrating an exemplary position of an observer with respect to the display apparatus as shown in FIG. 1.

Referring to FIG. 1, the display apparatus may include a control part 100, a display panel 200, an image processing part 300, a display driving part 400, an active barrier panel 500, a barrier control part 600 and a barrier driving part 700.

In an exemplary embodiment, the control part 100 receives a synchronization control signal CS, an image data signal DS, and an observer's position signal PS. The position signal PS may be output by a position sensor. The control part 100 generates a display control signal D_CS controlling a driving timing of the display panel 200 and a barrier control signal B_CS controlling a driving timing of the active barrier panel 500, based on the synchronization control signal CS.

The display panel 200 may include a plurality of data lines DL, a plurality of gate lines GL and a plurality of sub-pixels SP1 and SP2. The data lines DL are extended in a first direction D1 and arranged in a second direction D2 crossing the first direction D1. The gate lines GL are extended in the second direction D2 and arranged in the first direction D1. The sub-pixels SP1 and SP2 are electrically connected to the data lines DL and the gate lines GL and arranged as a matrix type. Each of the sub-pixels may include a color filter.

The image processing part 300 processes the image data signal DS to a three-dimensional (“3D”) image data signal to display a 3D image. For example, when the image data signal DS is the 3D image data signal which includes a left-eye data signal and a right-eye data signal, the image processing part 300 renders the left-eye data signal and the right-eye data signal using a predetermined sub-pixel rendering method.

Alternatively, when the image data signal DS is a two-dimensional (“2D”) image data signal, the image processing part 300 generates the left-eye data signal and the right-eye data signal using the 2D image data signal and renders the left-eye data signal and the right-eye data signal using a predetermined sub-pixel rendering method.

The display driving part 400 provides the display panel 200 with the left-eye and right-eye data signals received from the image processing part 300 based on the display control signal D_CS received from the control part 300. For example, the display driving part 300 provides a first sub-pixel SP1 with the left-eye data signal and a second sub-pixel SP2 adjacent the first sub-pixel SP1 in the second direction D2, with the right-eye data signal. Thus, the first sub-pixel SP1 displays a left-eye image corresponding to the left-eye data signal and the second sub-pixel SP2 displays a right-eye image corresponding to the right-eye data signal.

The active barrier panel 500 includes a plurality of electrode units EU. Each of the electrode units EU includes 2n barrier electrodes. For example, n barrier electrodes of the 2n barrier electrodes receive a first driving voltage to operate as an opening part transmitting light and the remaining n barrier electrodes of the 2n barrier electrodes receive a second driving voltage to operate as a barrier part blocking light.

The electrode unit EU is divided into an odd-numbered electrode part OE including the n barrier electrodes BE1, . . . , BEn and an even-numbered electrode part EE including the n barrier electrodes BE1, . . . , BEn. The odd-numbered or even-numbered electrode part OE or EE corresponds to one sub-pixel, and thus, the electrode unit EU may correspond to two sub-pixels SP1 and SP2. The driving voltage applied to the n barrier electrodes of the odd-numbered electrode part OE is opposite to the driving voltage applied to the n barrier electrodes of the even-numbered electrode part EE.

The electrode unit EU may have 2n barrier-shift modes according to the barrier part's position shifted toward a horizontal direction in the electrode unit EU.

The barrier electrodes BE1, . . . , Ben are extended in the first direction D1 and arranged in the second direction D2. In an exemplary embodiment, the number n of the barrier electrodes in the odd-numbered or even-numbered electrode part OE or EE is six. When the number n of the barrier electrodes is increased, a viewing area, in which a minimum crosstalk is maintained in the horizontal direction, may be increased. Thus, when the number n of the barrier electrodes is increased, an observer's horizontal movement area, in which the observer observes the 3D image having the minimum crosstalk, may be increased. However, when the number n of the barrier electrodes increases, a leakage light through a gap between the barrier electrodes increases. Therefore, the number n of the barrier electrodes should not be increased beyond a maximum in accordance with the leakage light by the gap between the barrier electrodes.

Although, not shown in the figures, the barrier electrodes BE1, . . . , Ben may be extended in a diagonal direction crossing the first and second directions D1 and D2 and arranged in the second direction D2. In addition, the active barrier panel 500 may be disposed adjacent the display panel 200, or under the display panel 200.

The barrier control part 600 determines the barrier-shift mode of every bather block of the active barrier panel 500 based on the observer's position signal PS received from the control part 100. The barrier control part 600 controls the barrier driving part 700 so that the barrier driving part 700 drives the electrode unit EU in the barrier block in the determined barrier-shift mode.

Referring to FIG. 2, the view distance (e.g., a straight distance) between the observer and the active barrier panel includes an optimum view distance (“OVD”), a near view distance (“NVD”) and a far-off view distance (“FVD”). The OVD is between the observer and the active barrier panel and may enable the observer to observe an optimum 3D image having a minimum crosstalk. The NVD is nearer than the OVD with respect to the active barrier panel and the FVD is further than the OVD with respect to the active barrier panel.

When the observer's view distance is the OVD, the barrier control part 600 determines the active area AA of the active barrier panel 500 as a single barrier block and controls the barrier driving part 700. Thus, the barrier driving part 700 drives the electrode unit EU of the active area AA in a barrier-shift mode. When the observer is shifted in the horizontal direction, for example, leftward or rightward, at the OVD, the barrier control part 600 controls the barrier driving part 700 so that the barrier driving part 700 shifts the barrier part in the barrier-shift mode corresponding to the observer's movement position. In addition, the image processing part 300 may render the left-eye image and the right-eye image displayed on the sub-pixels SP1 and SP2 according to the observer's movement position.

When the observer's view distance is outside the OVD, the barrier control part 600 calculates a crosstalk distribution of the observer's left-eye and right-eye by each of 2n barrier-shift modes with respect to the observer's position, divides an active area AA of the active barrier panel 500 into at least one barrier block based on a flat portion which maintains a minimum crosstalk in the crosstalk distribution and determines the barrier-shift mode by the barrier block to maintain the minimum crosstalk. The flat portion in the crosstalk distribution may be caused by a black pattern, for example, a black matrix, disposed in a boundary area of the sub-pixels. The barrier control part 600 controls the barrier driving part 700 so that the barrier driving part 700 drives the electrode unit EU of the barrier block in the barrier-shift mode determined from the barrier control part 600.

The barrier driving part 700 provides the barrier electrodes BE1, . . . , BEn of the barrier block with driving voltages according to a control of the barrier control part 600, so that the electrode unit EU of the barrier block is driven in the barrier-shift mode.

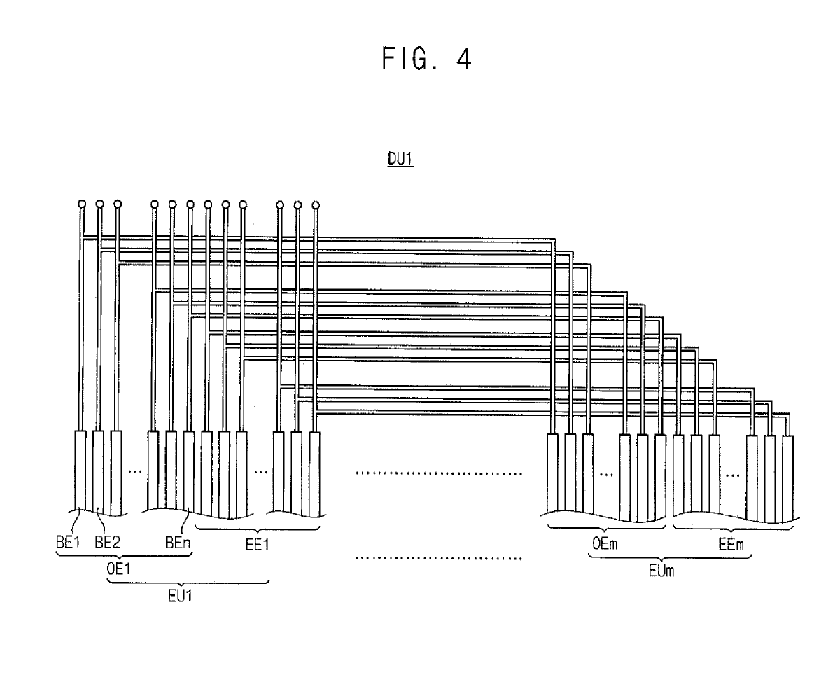

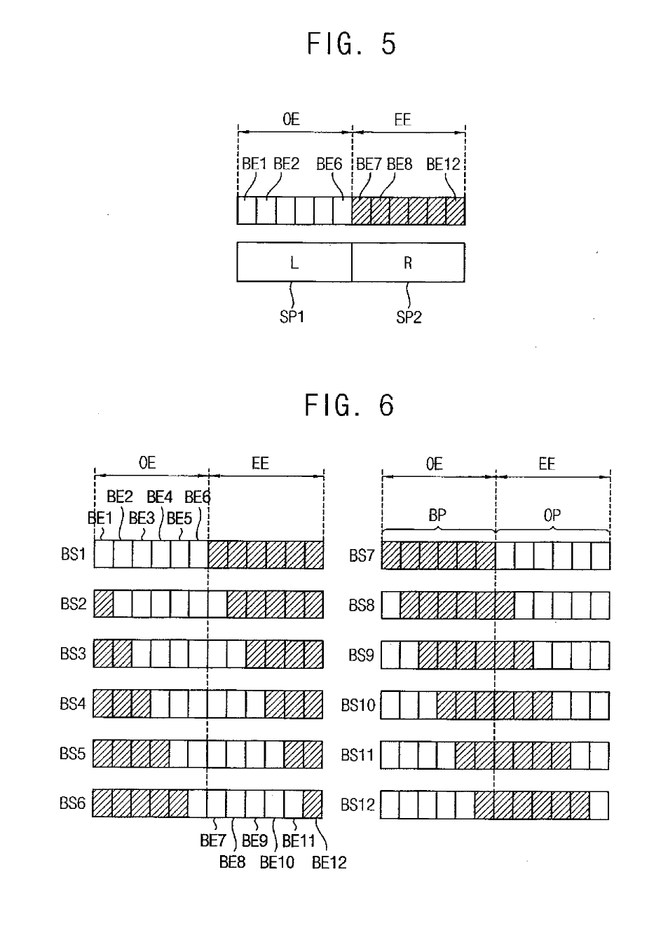

FIG. 3 is a plan view illustrating an active barrier panel shown in FIG. 1 according to an exemplary embodiment of the invention. FIG. 4 is a plan view illustrating a driving unit shown in FIG. 1 according to an exemplary embodiment of the invention.

Referring to FIGS. 3 and 4, the active barrier panel 500 includes a plurality of driving units DU1, DU2, DU3, . . . , DUk (herein, k is a natural number). The driving voltages applied to the barrier electrodes of the active barrier panel 500 are controlled by every driving unit.

As shown in FIG. 4, each driving unit (e.g., DU1) includes a plurality of electrode units EU1, EU2, EU3, . . . , EUm (herein, m is a natural number). The electrode unit EU1 includes an odd-numbered electrode part OE1 and an even-numbered electrode part EE1. Each of the odd-numbered and even-numbered electrode parts OE1 and EE1 includes a plurality of barrier electrodes BE1, BE2, . . . , BEn.

Referring to a first driving unit DU1, m first barrier electrodes BE1 in first to m-th odd-numbered electrode parts OE1, . . . , OEm are connected to each other, m second barrier electrodes BE2 in the first to m-th odd-numbered electrode parts OE1, . . . , OEm are connected to each other and m third barrier electrodes BE3 in the first to m-th odd-numbered electrode parts OE1, . . . , OEm are connected to each other. As described above, m n-th barrier electrodes BEn in the first to m-th odd-numbered electrode parts OE1, . . . , OEm are connected to each other.

Further, m first barrier electrodes BE1 in first to m-th even-numbered electrode parts EE1, . . . , EEm are connected each other, m second barrier electrodes BE2 in the first to m-th even-numbered electrode parts EE1, . . . , EEm are connected each other, and m third barrier electrodes BE3 in the first to m-th even-numbered electrode parts EE1, . . . , EEm are connected each other. As described above, m n-th barrier electrodes BEn in the first to m-th even-numbered electrode parts EE1, . . . , EEm are connected each other.

As shown in FIG. 4, (2n×m) barrier electrodes in the first to m-th electrode units EU1, . . . , EUm may be driven through 2n input channels.

Therefore, according to at least one exemplary embodiment, the m electrode units are grouped into a driving unit so that the number of driving chips for driving the active barrier panel 500 may be decreased.

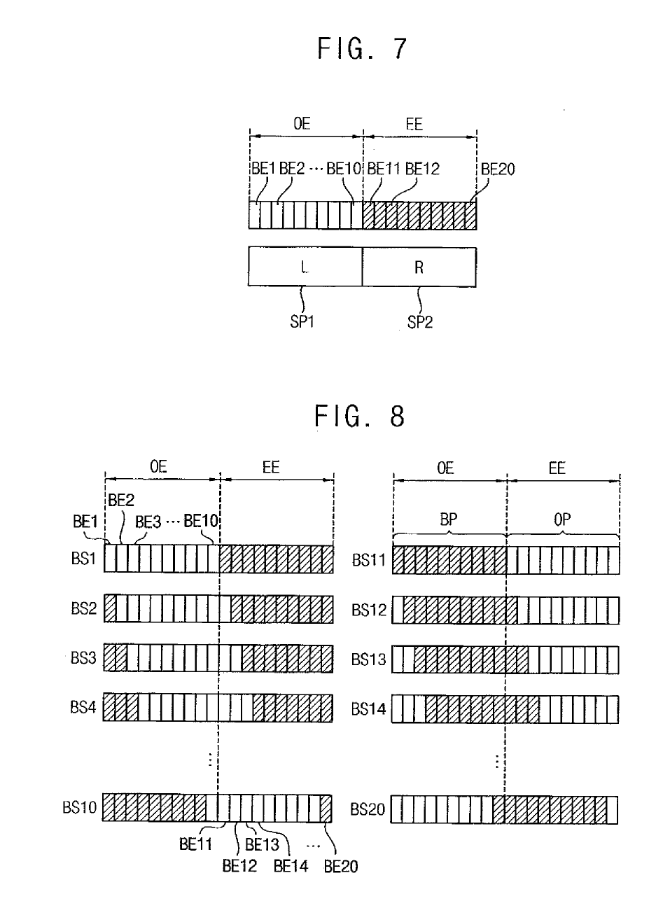

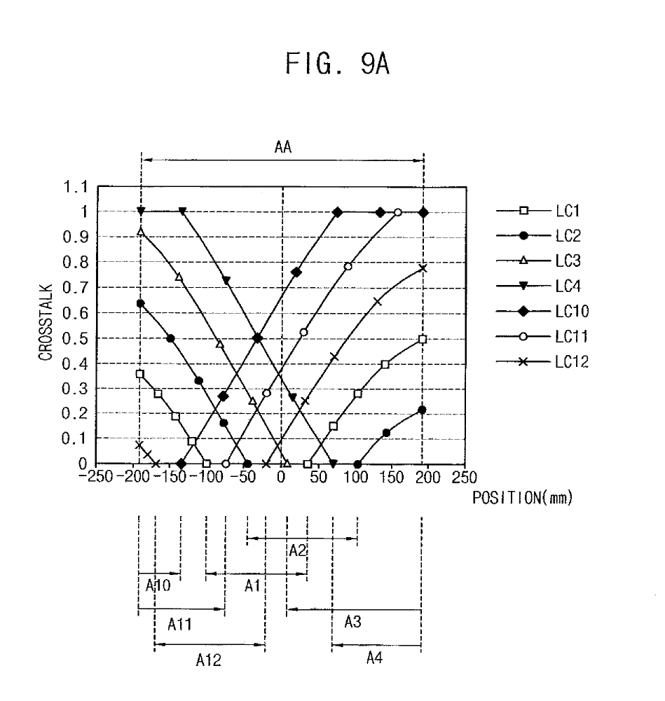

FIG. 5 is a conceptual diagram illustrating an electrode unit included in the active barrier panel shown in FIG. 1 according to an exemplary embodiment of the invention. FIG. 6 is a conceptual diagram illustrating a plurality of exemplary barrier-shift modes of the electrode unit shown in FIG. 5.

Referring to FIGS. 5 and 6, according to at least one exemplary embodiment of the invention, the electrode unit EU includes 12 barrier electrodes BE1 to BE12.

As shown in FIG. 5, the electrode unit EU includes an odd-numbered electrode part OE and an even-numbered electrode part EE. The odd-numbered electrode part OE corresponds to the first sub-pixel SP1 displaying the left-eye image L and the even-numbered electrode part EE corresponds to the second sub-pixel SP2 displaying the right-eye image R. The odd-numbered electrode part OE includes first to sixth barrier electrodes BE1 to BE6 and the even-numbered electrode part EE includes seventh to twelfth barrier electrode BE7 to BE12.

According to the present exemplary embodiment, the electrode unit EU may be driven in 12 barrier-shift modes corresponding to the 12 barrier electrodes. However, the invention is not limited thereto. For example, there may be additional or few barrier electrodes.

As shown in FIG. 6, a first barrier-shift mode BS1 includes first to sixth barrier electrodes BE1 to BE6 of the odd-numbered electrode part OE operated as an opening part OP transmitting the light and seventh to twelfth barrier electrodes BE7 to BE12 of the even-numbered electrode part EE operated as a barrier part BP blocking the light.

A second barrier-shift mode BS2 includes the barrier part BP which is shifted toward a first side by one barrier electrode with respect to the barrier part BP of the first barrier-shift mode BS1. In other words, the second barrier-shift mode BS2 includes second to seventh barrier electrodes BE2 to BE7 operated as the opening part OP, and first and eighth to twelfth barrier electrodes BE1, and BE8 to BE12 operated as the barrier part BP.

A third barrier-shift mode BS3 includes the barrier part BP which is shifted toward the first side by one barrier electrode with respect to the barrier part BP of the second barrier-shift mode BS2. In other words, the third barrier-shift mode BS3 includes third to eighth barrier electrodes BE3 to BE8 operated as the opening part OP and first, second, ninth to twelfth barrier electrode barrier electrodes BE1, BE2 and BE9 to BE12 operated as the barrier part BP.

Similar to the previous three barrier-shift modes described above, a fourth barrier-shift mode BS4 includes the barrier part BP which is shifted toward the first side by one barrier electrode with respect to the barrier part BP of the third barrier-shift mode BS3. A fifth barrier-shift mode BS4 includes the barrier part BP which is shifted toward the first side by one barrier electrode with respect to the barrier part BP of the fourth barrier-shift mode BS4. A sixth barrier-shift mode BS6 includes the barrier part BP which is shifted toward the first side by one barrier electrode with respect to the barrier part BP of the fifth barrier-shift mode BS5.

Each of seventh, eighth, ninth, tenth, eleventh and twelfth barrier-shift modes BS7, BS8, BS9, BS10, BS11 and BS12 includes the opening part and the barrier part operated opposite to those of each of the first, second, third, fourth, fifth and sixth barrier-shift modes BS1, BS2, BS3, BS4, BS5 and BS6, respectively.

For example, as shown in FIG. 6, the opening part OP of the seventh barrier-shift mode BS7 corresponds to the barrier part BP of the first barrier-shift mode BS1 and the barrier part BP of the seventh barrier-shift mode BS7 corresponds to the opening part of the first barrier-shift mode BS1. In other words, in the seventh barrier-shift mode BS7, the first to sixth barrier electrodes BE1 to BE6, which are operated as the opening part in the first barrier-shift mode BS1, are operated as the barrier part. In the seventh barrier-shift mode BS7, the seventh to twelfth barrier electrodes BE7 to BE12, which are operated as the barrier part in the first barrier-shift mode BS1, are operated as the opening part.

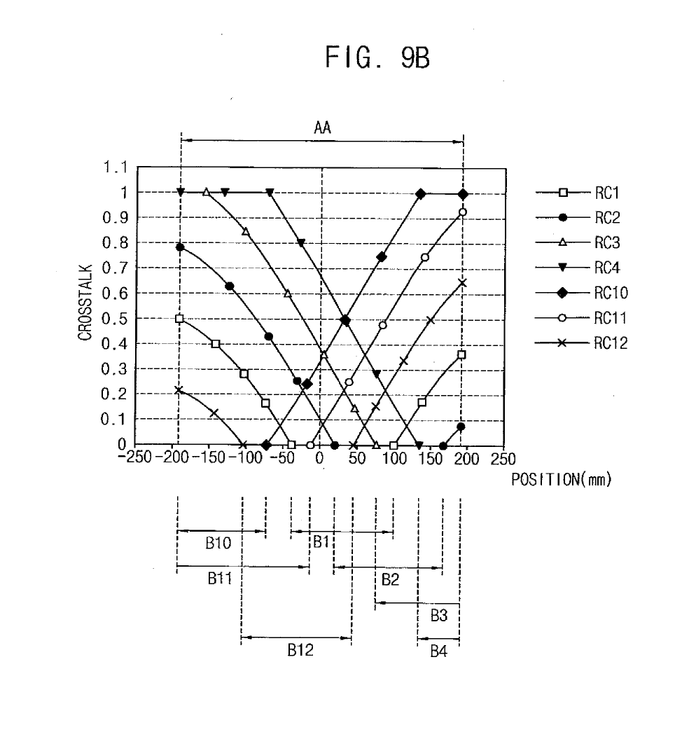

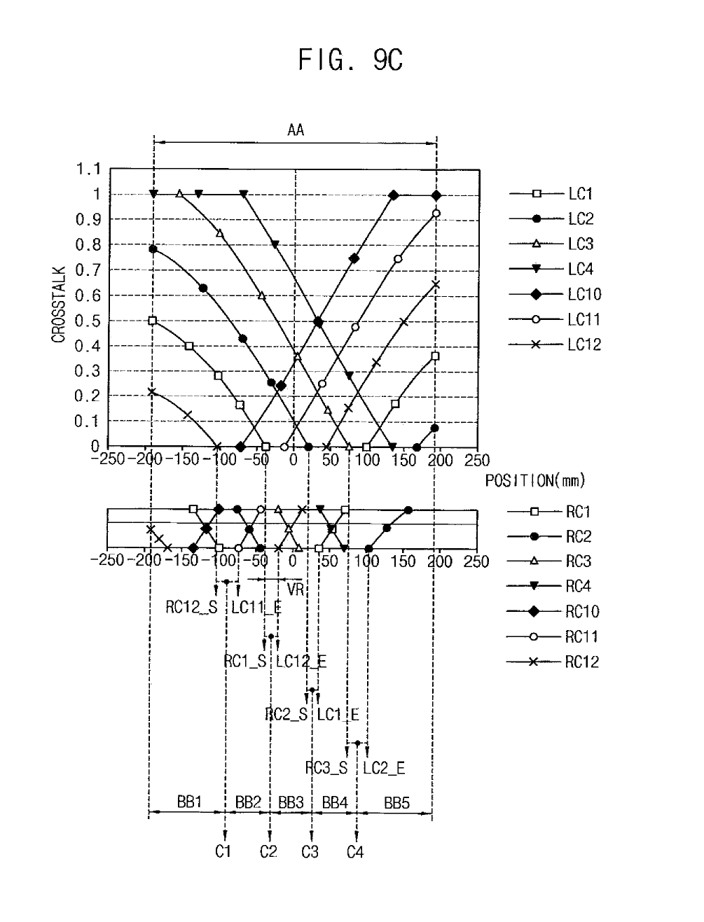

FIG. 7 is a conceptual diagram illustrating an electrode unit included in the active barrier panel shown in FIG. 1 according to an exemplary embodiment of the invention. FIG. 8 is a conceptual diagram illustrating a plurality of exemplary barrier-shift modes of the electrode unit shown in FIG. 7.

Referring to FIGS. 7 and 8, according to at least one exemplary embodiment of the invention, the electrode unit EU includes 20 barrier electrodes BE1 to BE20.

As shown in FIG. 7, the electrode unit EU includes an odd-numbered electrode part OE and an even-numbered electrode part EE. The odd-numbered electrode part OE corresponds to the first sub-pixel SP1 displaying the left-eye image L and the even-numbered electrode part EE corresponds to the second sub-pixel SP2 displaying the right-eye image R. The odd-numbered electrode part OE includes first to tenth barrier electrodes BE1 to BE10 and the even-numbered electrode part EE includes eleventh to twentieth barrier electrodes BE11 to BE20.

According to the present exemplary embodiment, the electrode unit EU may be driven in 20 barrier-shift modes corresponding to the 20 barrier electrodes. However, the invention is not limited thereto. For example, additional or fewer barrier electrodes may be present.

As shown in FIG. 8, a first barrier-shift mode BS1 includes first to tenth barrier electrodes BE1 to BE10 of the odd-numbered electrode part OE operated as an opening part OP transmitting the light and eleventh to twentieth barrier electrodes BE11 to BE20 of the even-numbered electrode part EE operated as a barrier part BP blocking the light

A second barrier-shift mode BS2 includes the barrier part BP which is shifted toward a first side by one barrier electrode with respect to the barrier part BP of the first barrier-shift mode BS1. In other words, the second barrier-shift mode BS2 includes second to eleventh barrier electrodes BE2 to BE11 operated as the opening part OP, and first and twelfth to twentieth barrier electrodes BE1, BE12 to BE20 operated as the barrier part BP.

A third barrier-shift mode BS3 includes the barrier part BP which is shifted toward the first side by one barrier electrode with respect to the barrier part BP of the second barrier-shift mode BS2. In other words, the third barrier-shift mode BS3 includes third to twelfth barrier electrodes BE3 to BE12 operated as the opening part OP, and first, second and thirteenth to twentieth barrier electrodes BE1, BE2 and BE13 to BE20 operated as the barrier part BP.

Similar to the previous three barrier-shift modes described above, a fourth barrier-shift mode BS4 includes the barrier part BP which is shifted toward the first side by one barrier electrode with respect to the barrier part BP of the third barrier-shift mode BS3. A fifth barrier-shift mode BS5 (not shown in FIG. 8) includes the barrier part BP which is shifted toward the first side by one barrier electrode with respect to the barrier part BP of the fourth barrier-shift mode BS4. A sixth barrier-shift mode BS6 (not shown in FIG. 8) includes the barrier part BP which is shifted toward the first side by one barrier electrode with respect to the barrier part BP of the fifth barrier-shift mode BS5. A seventh barrier-shift mode BS7 (not shown in FIG. 8) includes the barrier part BP which is shifted toward the first side by one barrier electrode with respect to the barrier part BP of the sixth barrier-shift mode BS6. An eighth barrier-shift mode BS8 (not shown in FIG. 8) includes the barrier part BP which is shifted toward the first side by one barrier electrode with respect to the barrier part BP of the seventh barrier-shift mode BS7. A ninth barrier-shift mode BS9 (not shown in FIG. 8) includes the barrier part BP which is shifted toward the first side by one barrier electrode with respect to the barrier part BP of the eighth barrier-shift mode BS8. A tenth barrier-shift mode BS10 includes the barrier part BP which is shifted toward the first side by one barrier electrode with respect to the barrier part BP of the ninth barrier-shift mode BS9.

Each of eleventh to twentieth barrier-shift modes BS11 to BS20 includes the opening part and the barrier part operated opposite to those of each of the first to tenth barrier-shift modes BS1 to BS10.

For example, as shown in FIG. 8, the opening part OP of the eleventh barrier-shift mode BS11 corresponds to the barrier part BP of the first barrier-shift mode BS1 and the barrier part BP of the eleventh barrier-shift mode BS11 corresponds to the opening part of the first barrier-shift mode BS1. In other words, in the eleventh barrier-shift mode BS11, the first to tenth barrier electrodes BE1 to BE10, which are operated as the opening part in the first barrier-shift mode BS1, are operated as the barrier part. In the eleventh barrier-shift mode BS11, the eleventh to twentieth barrier electrodes BE11 to BE20, which are operated as the barrier part in the first barrier-shift mode BS1, are operated the opening part.

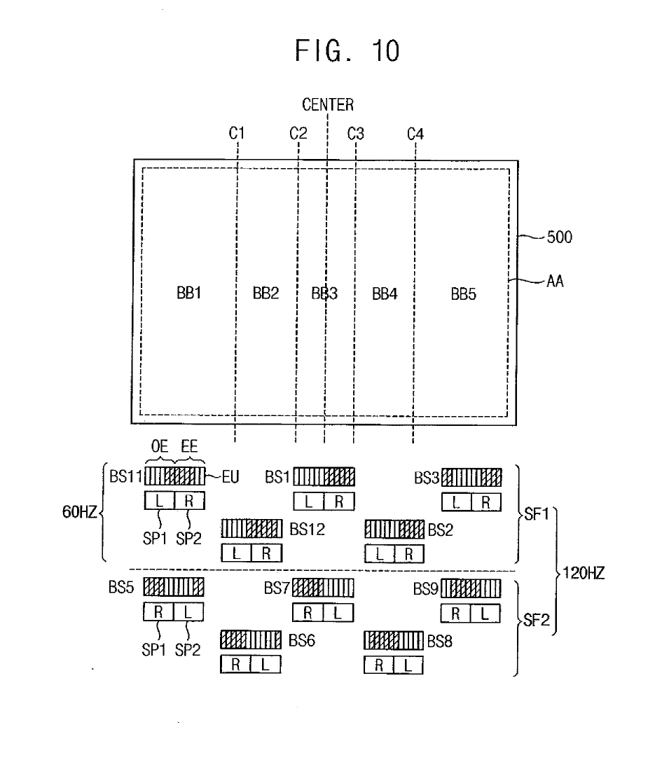

FIGS. 9A, 9B and 9C are conceptual diagrams illustrating a barrier control part, when a viewing distance between the observer and the display apparatus, is less than the OVD.

Hereinafter, when a horizontal length of the active area AA is about 382 mm, the number of the barrier electrodes divided in the electrode unit is about 12, the OVD is about 620 mm, the observer's view distance is about 540 mm and the observer is located in the center of the active area AA, a method of driving the active barrier panel is explained as an example. However, the invention is not limited thereto. For example, the horizontal length may be a value other than 382 mm, there may be fewer or greater than 12 barrier electrodes, the OVD may differ from 620 mm, and the observer's distance may differ from 540 mm.

Referring to FIGS. 1, 6 and 9A, the barrier control part 600 calculates a left-eye crosstalk distribution with respect to each the of first to twelfth barrier-shift modes BS1 to BS12 based on the observer's position. The left-eye crosstalk distribution is a graph of left-eye cross talk verses a horizontal position of the observer along the observer's view distance away from the active area. For example, the ‘0’ position on the graph indicates the observer is in alignment with the center of the active area, the ‘−50’ position indicates the observer is 50 mm out of alignment to the right, the ‘−50’ position indicates the observer is 50 mm output of alignment to the left, etc. If the observer view distance is 540 mm, the observer is a straight distance of 540 mm away from the center of the active area at the ‘0’ position, but is slightly further away than 540 mm at positions ‘50’ and ‘−50’ due to the resulting hypotenuse.

According to the calculated result, as shown in FIG. 9A, when the viewing distance is less than the OVD, flat portions of first, second, third, fourth, tenth, eleventh and twelfth left-eye crosstalk distributions LC1, LC2, LC3, LC4, LC10, LC11 and LC12 corresponding to first, second, third, fourth, tenth, eleventh and twelfth barrier-shift modes BS1, BS2, BS3, BS4, BS10, BS11 and BS12 exist in the active area AA (−200 mm to 200 mm) For example, when the active barrier panel is operated as the first barrier shift mode BS1, the first left-eye crosstalk distribution LC1 is observed by the observer's left-eye. When the active barrier panel is operated as the second barrier shift mode BS2, the second left-eye crosstalk distribution LC2 is observed by the observer's left-eye. When the active bather panel is operated as the third barrier shift mode BS3, the third left-eye crosstalk distribution LC3 is observed by the observer's left-eye. When the active barrier panel is operated as the fourth bather shift mode BS4, the fourth left-eye crosstalk distribution LC4 is observed by the observer's left-eye. When the active barrier panel is operated as the tenth barrier shift mode BS10, the tenth left-eye crosstalk distribution LC10 is observed by the observer's left-eye. When the active barrier panel is operated as the eleventh barrier shift mode BS11, the eleventh left-eye crosstalk distribution LC11 is observed by the observer's left-eye. When the active barrier panel is operated as the twelfth barrier shift mode BS12, the twelfth left-eye crosstalk distribution LC12 is observed by the observer's left-eye.

The first left-eye crosstalk distribution LC1 generated by the first barrier-shift mode BS1, includes a flat portion, in which a minimum crosstalk is maintained, in a first area A1. Wherein, a value of the minimum crosstalk may be “0” as shown in FIG. 9A. For example, a flat portion may indicate that the slope of a curve on the left-eye cross talk distribution for a particular barrier-shift mode is 0 or infinite depending on which axis is used to represent the horizontal position of the observer and the crosstalk experienced. The second left-eye crosstalk distribution LC2 generated by the second barrier-shift mode BS2 includes the flat portion in a second area A2. As shown in FIG. 9A, the third, fourth, tenth, eleventh and twelfth left-eye crosstalk distributions LC3, LC4, LC10, LC11 and LC12 include the flat portion in third, fourth, tenth, eleventh and twelfth areas A3, A4, A10, A11 and A12, respectively. For example, there are cases where even though the observer is slightly offset from the center of the active area AA, they will experience no left-eye cross talk when certain barrier-shift modes are used. For example, in the example shown in FIG. 9A, if the observer is offset at positions −50 or 100, they would experience no left-eye cross talk if the second barrier shift mode BS2 is used.

Referring to FIGS. 1, 6 and 9B, the barrier control part 600 calculates a right-eye crosstalk distribution with respect to each the of first to twelfth barrier-shift modes BS1 to BS12 based on the observer's position (view distance). The right-eye crosstalk distribution is a graph of right-eye cross talk verses a horizontal position of the observer along the observer's view distance. For example, the ‘0’ position on the graph indicates the observer is in alignment with the center of the active area, the ‘50’ position indicates the observer is 50 mm out of alignment to the right, the ‘−50’ position indicates the observer is 50 mm output of alignment to the left, etc. If the observer view distance is 540 mm, the observer is a straight distance of 540 mm away from the center of the active area at the ‘0’ position, but is slightly further away than 540 mm at positions ‘50’ and ‘−50’ due to the resulting hypotenuse.

According to the calculated result, as shown in FIG. 9B, when the viewing distance is less than the OVD, the flat portions of first, second, third, fourth, tenth, eleventh and twelfth right-eye crosstalk distributions RC1, RC2, RC3, RC4, RC10, RC11 and RC12 corresponding to first, second, third, fourth, tenth, eleventh and twelfth barrier-shift modes BS1, BS2, BS3, BS4, BS10, BS11 and BS12 exist in the active area AA. For example, when the active barrier panel is operated as the first barrier shift mode BS1, the first right-eye crosstalk distributions RC1 is observed by the observer's right-eye. As described above, when the active barrier panel is operated as each of the second, third, fourth, tenth, eleventh and twelfth barrier-shift modes BS2, BS3, BS4, BS10, BS11 and BS12, each of the second, third, fourth, tenth, eleventh and twelfth right-eye crosstalk distribution LC2 is observed by the observer's right-eye.

The first right-eye crosstalk distribution RC1 generated by the first barrier-shift mode BS1, includes the flat portion, in which a minimum crosstalk is maintained, in a first area B1. Wherein, a value of the minimum crosstalk may be “0” as shown in FIG. 9B. For example, a flat portion indicates that the slope of a curve on the right-eye cross talk distribution for a particular barrier-shift mode is 0 or infinite depending on which axis is used to represent the horizontal position of the observer and the crosstalk experienced. The second right-eye crosstalk distribution RC2 generated by the second barrier-shift mode BS2 includes the flat portion in a second area B2. As shown in FIG. 9A, the third, fourth, tenth, eleventh and twelfth right-eye crosstalk distributions RC3, RC4, RC10, RC11 and RC12 include the flat portion in third, fourth, tenth, eleventh and twelfth areas B3, B4, B10, B11 and B12, respectively. For example, there are cases where even though the observer is slightly offset from the center of the active area AA, they will experience no right-eye cross talk when certain barrier-shift modes are used. For example, in the example shown in FIG. 9B, if the observer is offset at positions −50 or 100, they would experience no right-eye cross talk if the first barrier shift mode BS1 is used.

Referring to FIGS. 9A, 9A and 9C, the bather control part 600 divides the active area AA of the active barrier panel 500 into at least one barrier block based on flat portions in the left-eye and right-eye crosstalk distributions, and determines the barrier-shift mode corresponding to the bather block so that the 3D image through the barrier block has a minimum or crosstalk.

The barrier control part 600 determines a boundary of the barrier block. The boundary is determined by a central portion between a first end portion of the flat portion in an N-th right-eye crosstalk distribution corresponding to an N-th barrier-shift mode and an end portion of the flat portion in an (N−1)-th left-eye crosstalk distribution corresponding to an (N−1)-th barrier-shift mode. The (N−1)-th barrier-shift mode includes the barrier part shifted toward a second side opposite to the first side by one barrier electrode with respect to the barrier part of the N-th bather-shift mode.

For example, as shown in FIG. 9C, a first boundary C1 is determined by a central portion between a first end portion of the flat portion RC12_S in a twelfth right-eye crosstalk distribution RC12 and an end portion LC11_E of the flat portion in an eleventh left-eye crosstalk distribution LC11. A second boundary C2 is determined by a central portion between a first end portion of the flat portion RC1_S in a first right-eye crosstalk distribution RC1 and an end portion LC12_E of the flat portion in a twelfth left-eye crosstalk distribution LC12. A third boundary C3 is determined by a central portion between a first end portion of the flat portion RC2_S in a second right-eye crosstalk distribution RC2 and an end portion LC1_E of the flat portion in a first left-eye crosstalk distribution LC1. A fourth boundary C4 is determined by a central portion between a first end portion of the flat portion RC3_S in a third right-eye crosstalk distribution RC3 and an end portion LC2_E of the flat portion in a second left-eye crosstalk distribution LC2.

The barrier control part 600 divides the active area AA of the active barrier panel 500 into first, second, third, fourth and fifth barrier blocks BB1, BB2, BB3, BB4 and BB5 based on the first to fourth boundaries C1, C2, C3 and C4.

The barrier control part 600 determines the barrier-shift mode for every barrier block so that the flat portions of the left-eye and right-eye crosstalk distributions are maintained.

The first barrier block BB1 corresponds to an overlap area in which the eleventh area A11 as shown in FIG. 9A overlaps with the eleventh area B11 as shown in FIG. 9B. The eleventh area A11 as shown in FIG. 9A includes the flat portion of the eleventh left-eye crosstalk distribution LC11 and the eleventh area B11 as shown in FIG. 9B includes the flat portion of the eleventh right-eye crosstalk distribution RC11. Therefore, the first barrier block BB1 is determined as the eleventh barrier-shift mode BS11, so that the electrode unit EU in the first barrier block BB1 is operated as the eleventh barrier-shift mode BS11.

The second barrier block BB2 corresponds to an overlap area in which the twelfth area A12 as shown in FIG. 9A overlaps with the twelfth area B12 as shown in FIG. 9B. The twelfth area A12 as shown in FIG. 9A includes the flat portion of the twelfth left-eye crosstalk distribution LC12 and the twelfth area B12 as shown in FIG. 9B includes the flat portion of the twelfth right-eye crosstalk distribution RC12. Therefore, the second barrier block BB2 is determined as the twelfth barrier-shift mode BS12, so that the electrode unit. EU in the second barrier block BB2 is operated as the twelfth barrier-shift mode BS12.

The third barrier block BB3 corresponds to an overlap area in which the first area A1 as shown in FIG. 9A overlaps with the first area B1 as shown in FIG. 9B. The first area Al as shown in FIG. 9A includes the flat portion of the first left-eye crosstalk distribution LC1 and the first area B1 as shown in FIG. 9B includes the flat portion of the first right-eye crosstalk distribution RC1. Therefore, the third barrier block BB3 is determined as the first barrier-shift mode BS1, so that the electrode unit EU in the third barrier block BB3 is operated as the first barrier-shift mode BS1.

The fourth barrier block BB4 corresponds to an overlap area in which the second area A2 as shown in FIG. 9A overlaps with the second area B2 as shown in FIG. 9B. The second area A2 as shown in FIG. 9A includes the flat portion of the second left-eye crosstalk distribution LC2 and the second area B2 as shown in FIG. 9B includes the flat portion of the second right-eye crosstalk distribution RC2. Therefore, the fourth barrier block BB4 is determined as the second barrier-shift mode BS2, so that the electrode unit EU in the fourth barrier block BB4 is operated as the second barrier-shift mode BS2.

The fifth bather block BB5 corresponds to an overlap area in which the third area A3 as shown in FIG. 9A overlaps with the third area B3 as shown in FIG. 9B. The third area A3 as shown in FIG. 9A includes the flat portion of the third left-eye crosstalk distribution LC3 and the third area B3 as shown in FIG. 9B includes the flat portion of the third right-eye crosstalk distribution RC3. Therefore, the fifth barrier block BB5 is determined as the third barrier-shift mode BS3, so that the electrode unit EU in the fifth barrier block BB5 is operated as the third barrier-shift mode BS3.

As shown in FIG. 9C, when the observer's view distance is less than the OVD, the barrier-shift modes of a left-side with respect to the center area O of the active barrier panel 500 have the first, twelfth and eleventh barrier-shift modes, sequentially and the barrier-shift modes of a right-side with respect to the center area O of the active barrier panel 500 have the first, second and third barrier-shift modes, sequentially. In other words, the third barrier block BB3 including the center area O has the first barrier-shift mode BS1, the second barrier block BB2 which is located toward the left-side with respect to the third barrier block BB3 has the twelfth barrier-shift mode BS12 decreased by one step from the first barrier-shift mode BS1 and the first bather block BB1 which is located toward the left-side with respect to the second barrier block BB2 has the eleventh barrier-shift mode BS11 decreased by one step from the twelfth barrier-shift mode BS12. In addition, the fourth barrier block BB4 which is located toward the right-side with respect to the third barrier block BB3 has the first barrier-shift mode BS1 increased by one step from the first barrier-shift mode BS1 and the fifth barrier block BB5 which is located toward the right-side with respect to the fourth barrier block BB4 has the third barrier-shift mode BS3 increased by one step from the second barrier-shift mode BS1 Therefore, the barrier blocks BB1, BB2, BB3, BB4 and BB5 may have the barrier-shift modes BS11, BS12, BS1, BS2 and BS3 increased by one step.

Referring to FIG. 9C, the viewing area VR exists between the first end portion of the flat portion in the right-eye crosstalk distribution and the second end portion of the flat portion in the left-eye crosstalk distribution.

The viewing area VR is determined by the number of the barrier electrodes in the electrode unit. As shown by the following Table 1, the viewing area VR is determined by the number of the barrier electrodes in the odd-numbered or even-numbered electrode part.

TABLE 1

| | VIEWING AREA | | | |
|---|---|---|---|---|
| | ACCORDING TO THE NUMBER OF | | | |
| VIEW | BARRIER ELECTRODES | | | |
| DISTANCE | 6 ea | 8 ea | 10 ea | 12 ea |
| 740 mm | ±3.5 mm | ±4.5 mm | ±5.5 mm | ±6.5 mm |
| 680 mm | ±5.0 mm | ±6.5 mm | ±7.5 mm | ±7.5 mm |
| 580 mm | ±3.5 mm | ±4.5 mm | ±5.5 mm | ±5.5 mm |
| 540 mm | ±1.5 mm | ±2.5 mm | ±3.5 mm | ±4.0 mm |

Data in Table 1 are computer simulation data, when the horizontal length of the active area AA is about 382 mm and the OVD is about 620 mm.

Referring to Table 1, in the view distance of about 540 mm, when the number of the barrier electrodes divided in the electrode unit is about 6×2, the viewing area is about ±1.5 mm. When the number of the barrier electrodes divided in the electrode unit is about 12×2, the viewing area is about ±4.0 mm. Therefore, when the number of the barrier electrodes divided in the electrode unit is increased in the same view distance, the viewing area is increased.

According to at least one embodiment of the present invention, the viewing area may be determined by the number of the barrier electrodes divided in the electrode unit. When the number of the barrier electrodes divided in the electrode unit is sufficiently increased, the observer is free to move horizontally with minimal crosstalk.

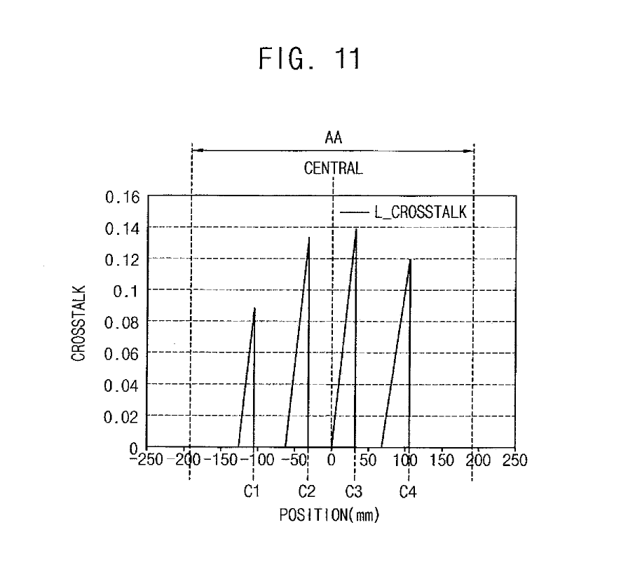

FIG. 10 is a conceptual diagram illustrating a method of driving the active barrier panel by the barrier control part shown in FIGS. 9A, 9B and 9C according to an exemplary embodiment of the invention.

Referring to FIGS. 1 and 10, the barrier control part 600 controls the barrier driving part 700 based on the barrier-shift mode determined by for each barrier block

The barrier driving part 700 provides the barrier electrodes in the electrode unit with driving voltages based on the barrier-shift mode. First driving voltages are applied to the barrier electrodes operating as the opening part and second driving voltages are applied to the barrier electrodes operating as the barrier part. For example, the barrier driving part 700 provides the barrier electrodes in the even-numbered electrode part EE with the driving voltages which are opposite to the driving voltage applied to the barrier electrodes in the odd-numbered electrode part OE.

The first sub-pixel SP1 of the display panel corresponding to the odd-numbered electrode part OE displays the left-eye image L and the second sub-pixel SP2 of the display panel corresponding to the even-numbered electrode part EE displays the right-eye image R.

Each of the barrier blocks of the active barrier panel 500 is operated in the determined barrier-shift mode. As shown in FIG. 10, the electrode unit EU in the first bather block BB1 is operated in the eleventh barrier-shift mode BS11, the electrode unit EU in the second barrier block BB2 is operated in the twelfth barrier-shift mode BS12, the electrode unit EU in the third barrier block BB3 is operated in the first barrier-shift mode BS1, the electrode unit EU in the fourth barrier block BB4 is operated in the second barrier-shift mode BS2 and the electrode unit EU in the fifth barrier block BB5 is operated in the third barrier-shift mode BS3.

Therefore, the observer may observe a 3D image having a minimum crosstalk at a view distance less than the OVD.

As an example, the display panel and the active barrier panel may be driven at a frame frequency of about 60 Hz, but the inventive is not limited thereto. The display panel and the active barrier panel may be driven at a frame frequency of about 120 Hz so that a resolution of the 3D image is substantially the same as that of the 2D image. However, the invention is not limited thereto. For example, 3D images of the same resolution as the 2D images may be presented by driving the display panel and the active barrier panel may at a frame frequency that is twice that used for the 2D images.

For example, during a first sub frame SF1, the display panel and the active barrier panel is driven using the collection of barrier-shift modes described above.

Then, during a second sub frame SF2, the first and second sub-pixels SP1 and SP2 display the images opposite to the left-eye and right-eye images L and R respectively displayed on the first and second sub-pixels SP1 and SP2 during the first sub frame SF1. Thus, the first sub-pixel SP1 displays the right-eye image R and the second sub-pixel SP2 displays the left-eye image.

In addition, during a second sub frame SF2, each of the barrier blocks of the active barrier panel 500 is operated using the barrier-shift modes opposite to the barrier-shift modes used in the first sub frame SF1. During the second sub frame, the barrier electrodes operated as the opening part in the first sub frame SF1, are operated as the barrier part and the barrier electrodes operated as the barrier part in the first sub frame SF1, are operated as the opening part.

Thus, during the second sub frame SF2, the first barrier block BB1 is operated in the fifth barrier-shift mode BS5 opposite to the eleventh barrier-shift mode BS11, the second barrier block BB2 is operated in the sixth barrier-shift mode BS6 opposite to the twelfth barrier-shift mode BS12, the third barrier block BB3 is operated in the seventh barrier-shift mode BS7 opposite to the first barrier-shift mode BS1, the fourth barrier block BB4 is operated in the eighth barrier-shift mode BS8 opposite to the second barrier-shift mode BS2, and the fifth barrier block BB5 is operated in the ninth barrier-shift mode BS9 opposite to the third barrier-shift mode BS3.

Therefore, the observer may observe a 3D image having a minimum crosstalk at a view distance less than the OVD. In addition, the display panel and the active barrier panel may be driven using a frame frequency of about 120 Hz so that the 3D image may have the resolution of the 2D image.

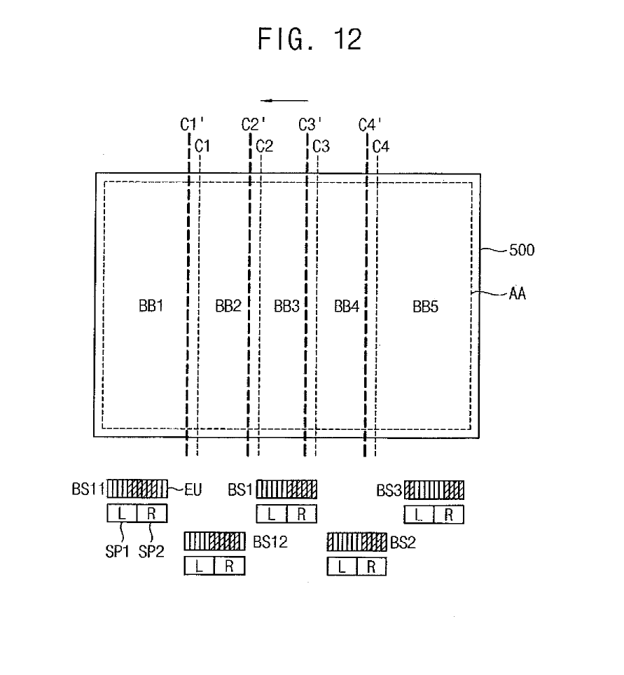

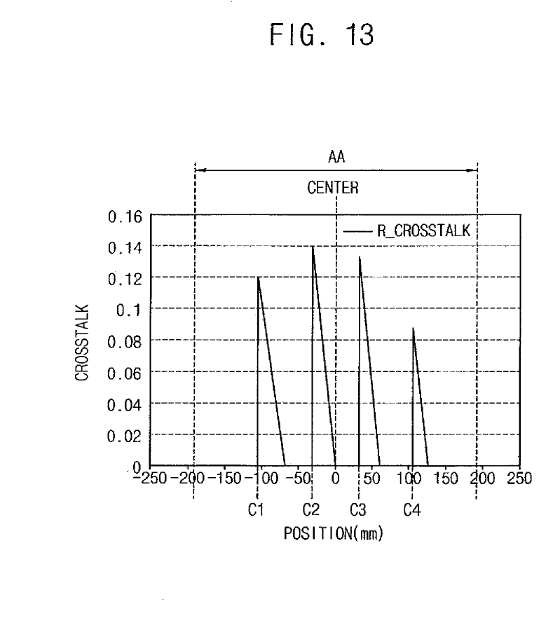

FIG. 11 is a conceptual diagram illustrating a left-eye crosstalk being observed by an observer's left-eye, when the observer moves toward a left-side along the view distance. FIG. 12 is a conceptual diagram illustrating a method of driving the active barrier panel, which may be reduce the left-eye crosstalk shown in FIG. 11.

Hereinafter, when a horizontal length of the active area AA is about 382 mm, the number of the barrier electrodes divided in the electrode unit is about 12, the OVD is about 620 mm, the observer's view distance is about 540 mm and the observer is located in the center are of the active area AA, a method of driving the active barrier panel is explained as an example. However, the invention is not limited thereto. For example, the horizontal length may differ from 382 mm, the number of the barrier electrodes may differ from 12, the OVD may differ from 620 nun, and the observer's view distance may differ from 540 mm.

Referring to FIG. 11 and Table 1, when the observer is shifted by about 6.3 mm toward the left-side with respect to the center area CENTER of the active barrier panel, the left-eye crosstalk observed through the observer's left-eye is increased in areas corresponding to the first to fourth boundaries C1 to C4.

As described referring to Table 1, when the view distance is about 540 mm, the number of the barrier electrodes divided in the electrode unit is about 6×2, the viewing area is about ±1.5 mm. Thus, when an observer's movement position is outside the viewing area, the left-eye crosstalk is increased.

When the observer's movement position is outside the viewing area, the barrier control part 600 determines the first to fourth boundaries C1 to C4 based on the observer's view distance and the first to fourth boundaries C1 to C4 are shifted based on the observer's movement position shifted toward the left-side with respect to the center area CENTER. Thus, the barrier control part 600 finally determines the shifted first to fourth boundaries C1′ to C4′.

Referring to FIG. 12, the barrier control part 600 divides the active area AA of the active barrier panel into first to fifth barrier blocks BB1 to BB5 based on the first to fourth boundaries C1′ to C4′, and controls the barrier driving part 700 so that each of the barrier blocks BB1 to BB5 is operated in the determined barrier-shift mode. In this case, the method of driving the active barrier panel 500 by the barrier driving part 700 is substantially the same as those described referring to FIG. 10 and the same detailed explanations are not repeated.

Therefore, when the observer is shifted toward the left-side along the view distance, the observer may observe the 3D image without the crosstalk or with minimal crosstalk.

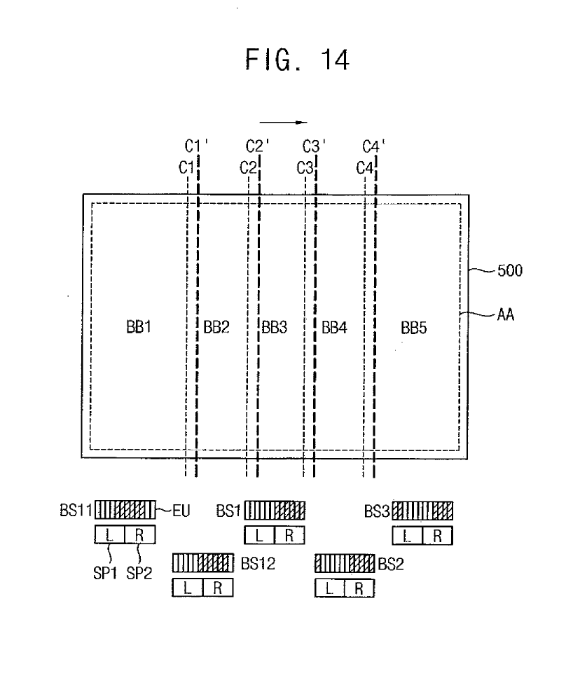

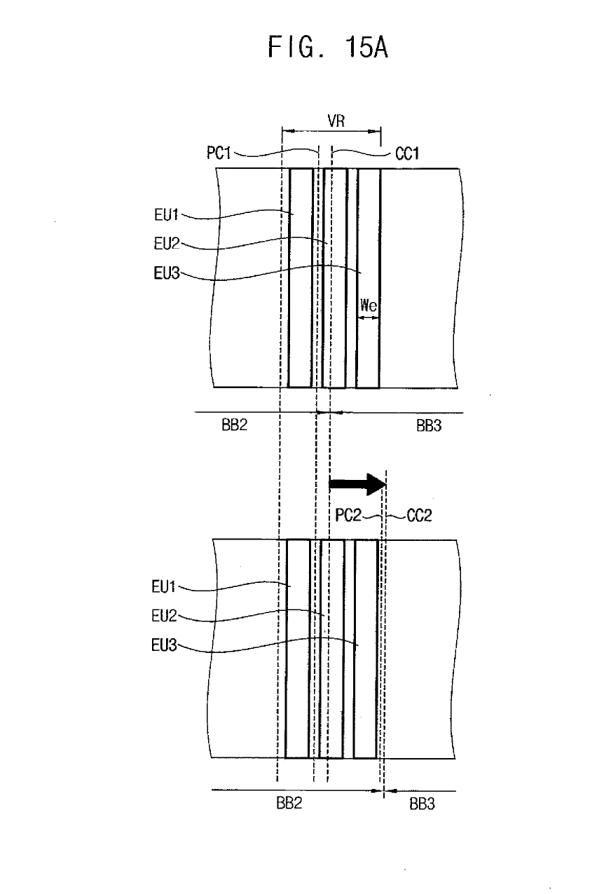

FIG. 13 is a conceptual diagram illustrating a right-eye crosstalk being observed by an observer's right-eye, when the observer moves toward a right-side along the view distance. FIG. 14 is a conceptual diagram illustrating a method of driving the active barrier panel, which may reduce the left-eye crosstalk shown in FIG. 13. Hereinafter, when a horizontal length of the active area AA is about 382 mm, the number of the barrier electrodes divided in the electrode unit is about 12, the OVD is about 620 mm, the observer's view distance is about 540 mm and the observer is located in the center are of the active area AA, a method of driving the active barrier panel is explained as an example. However, the invention is limited thereto. For example, the horizontal length may differ from 382 mm, the number of the barrier electrodes may differ from 12, the OVD may differ from 620 mm, and the observer's view distance may differ from 540 mm.

Referring to FIG. 13 and Table 1, when the observer is shifted by about 6.3 mm toward the right-side with respect to the center area CENTER of the active barrier panel, the right-eye crosstalk observed through the observer's right-eye is increased in areas corresponding to the first to fourth boundaries C1 to C4.

As described referring to Table 1, when the view distance is about 540 mm, the number of the barrier electrodes divided in the electrode unit is about 6×2, the viewing area is about ±1.5 mm. Thus, when an observer's movement position is outside the viewing area, the right-eye crosstalk is increased.

When the observer's movement position is outside the viewing area, the barrier control part 600 determines the first to fourth boundaries C1 to C4 based on the observer's view distance, and the first to fourth boundaries C1 to C4 are shifted based on the observer's movement position toward the right-side with respect to the center area CENTER. Thus, the barrier control part 600 finally determines the shifted first to fourth boundaries C1′ to C4′.

Referring to FIG. 14, the barrier control part 600 divides the active area AA of the active barrier panel into first to fifth barrier blocks BB1 to BB5 based on the first to fourth boundaries C1′ to C4′, and controls the barrier driving part 700 so that each of the barrier blocks BB1 to BB5 is operated in the determined barrier-shift mode. In this case, the method of driving the active barrier panel 500 by the barrier driving part 700 is substantially the same as those explained referring to FIG. 10 and the same detailed explanations are not repeated.

Therefore, when the observer is shifted toward the right-side along the view distance, the observer may observe the 3D image without the crosstalk or with minimal cross talk.

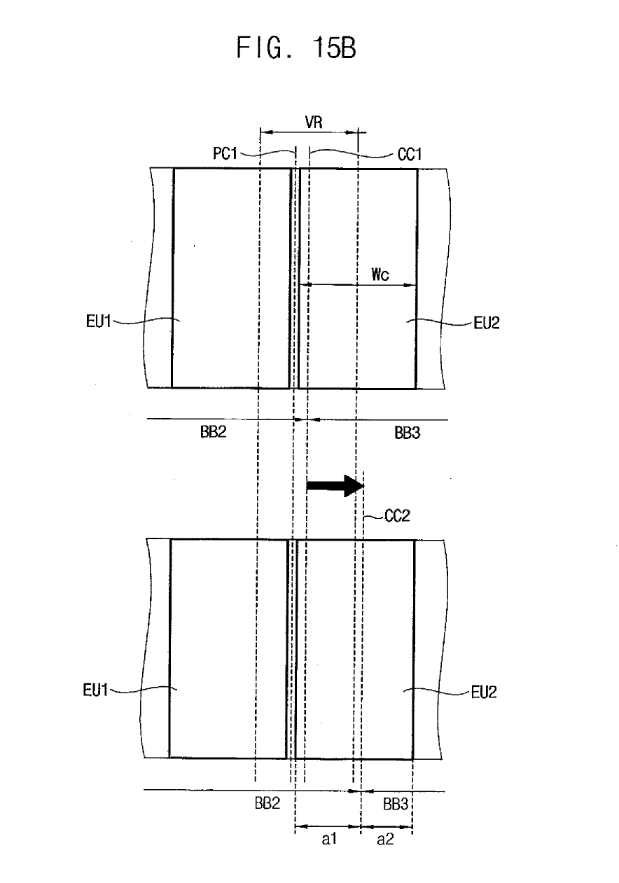

FIGS. 15A and 15B are conceptual diagrams illustrating a correlation between a width of the electrode unit and a viewing area.

Referring to FIG. 15A, according to an exemplary embodiment, a width We of the electrode unit is less than the viewing area VR determined according to the active barrier panel.

The active barrier panel is divided by a first calculating boundary CC1 calculated from the barrier control part. However, the barrier block is substantially divided by a first physical boundary PC1 adjacent the first calculating boundary CC1. The first physical boundary PC1 is a gap between the barrier electrodes. As shown in FIG. 15A, the first electrode unit EU1 is included in the second barrier block BB2 and the second and third electrode units EU2 and EU3 are included in the third barrier block BB3.

In this case, when the observer's movement position shifted toward the right-side is outside the viewing area VR, the barrier control part shifts the first calculating boundary CC1 to a second calculating boundary CC2 based on the observer's movement position. When the width We of the electrode unit is less than the viewing area VR, the second calculating boundary CC2 is located outside the third electrode unit EU3 as shown in FIG. 15A.

Therefore, the third electrode unit EU3 is included in the second barrier block divided by the second calculating boundary CC2. Thus, the third electrode unit EU3 may be operated in the barrier-shift mode determined corresponding to the second barrier block. Therefore, the crosstalk of the 3D image may be reduced.

Referring to FIG. 15B, according to an exemplary embodiment, a width We of the electrode unit is greater than the viewing area VR determined according to the active barrier panel.

The active barrier panel is divided by a first calculating boundary CC1 calculated from the barrier control part. However, the barrier block is substantially divided by a first physical boundary PC1 adjacent the first calculating boundary CC1. The first physical boundary PC1 is a gap between the barrier electrodes. As shown in FIG. 15B, the first electrode unit EU1 is included in the second barrier block BB2 and the second electrode unit EU2 is included in the third barrier block BB3.

In this case, when the observer's movement position shifted toward the right-side is outside the viewing area VR, the barrier control part shifts the first calculating boundary CC1 to a second calculating boundary CC2 based on the observer's movement position. When the width We of the electrode unit is greater than the viewing area VR, the second calculating boundary CC2 is located in an area in which the second electrode unit EU2 is disposed, as shown in FIG. 15B.

By the second calculating boundary CC2, a first area al of the second electrode unit EU2 is included in the second barrier block BB2 and a second area a2 of the second electrode unit EU2 is included in the third bather block BB3. However, the second electrode unit EU2 is not physically divided into the first and second areas a1 and a2 and the first and second areas al and a2 are not individually driven. Thus, the second electrode unit EU2 is included in one of the second and third barrier blocks BB2 and BB3 to be operated in the barrier-shift mode.

When the second electrode unit EU2 is includes in the second barrier block BB2 and is operated as the barrier-shift mode corresponding to the second barrier block BB2, crosstalk occurs in the second area a2. Alternatively, the second electrode unit EU2 is included in the third barrier block BB3 and is operated in the barrier-shift mode corresponding to the third barrier block BB3, such that crosstalk occurs in the first area a1.

Therefore, when the width We of the electrode unit is less than the viewing area VR according to an exemplary embodiment, the observer shifted toward the horizontal direction may observe the 3D image having the minimum crosstalk.

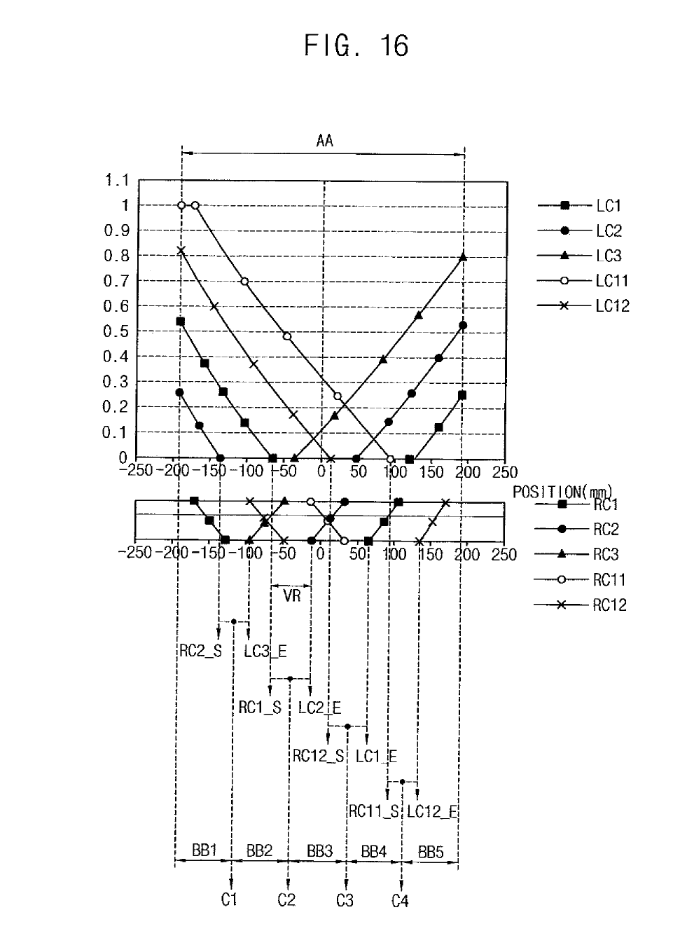

FIG. 16 is a conceptual diagram illustrating a barrier control part, when a viewing distance between the observer and the display apparatus is more than the OVD.

Hereinafter, when a horizontal length of the active area AA is about 382 mm, the number of the barrier electrodes divided in the electrode unit is about 12, the OVD is about 620 mm, the observer's view distance is about 740 mm and the observer is located in the center area of the active area AA, a method of driving the active barrier panel is explained as an example. However, the invention is limited thereto. For example, the horizontal length may differ from 382 mm, the number of the barrier electrodes may differ from 12, the OVD may differ from 620 mm, and the observer's view distance may differ from 740 mm.

Referring to FIGS. 1 and 16, the barrier control part 600 calculates a left-eye crosstalk distribution with respect to each the of first to twelfth bather-shift modes BS1 to BS12 based on the observer's position. According to the calculated result, as shown in FIG. 16, when the viewing distance is more than the OVD, the flat portions of when the viewing distance is more than the OVD, the flat portions of first, second, third, eleventh and twelfth left-eye crosstalk distributions LC1, LC2, LC3, LC11 and LC12 corresponding to first, second, third, eleventh and twelfth barrier-shift modes BS1, BS2, BS3, BS11 and BS12 exist in the active area AA.

In addition, the barrier control part 600 calculates a right-eye crosstalk distribution with respect to each the of first to twelfth barrier-shift modes BS1 to BS12 based on the observer's position. According to the calculated result, as shown in FIG. 16, when the viewing distance is more than the OVD, the flat portions of first, second, third, eleventh and twelfth right-eye crosstalk distributions RC1, RC2, RC3, RC11 and RC12 corresponding to first, second, third, eleventh and twelfth barrier-shift modes BS1, BS2, BS3, BS11 and BS12 exist in the active area AA.

Therefore, the barrier control part 600 divides the active area AA of the active barrier panel 500 into at least one barrier block based on flat portions in the left-eye and right-eye crosstalk distributions, and determines the barrier-shift mode corresponding to the barrier block so that the 3D image through the barrier block may have the minimum crosstalk.

The barrier control part 600 determines a boundary of the barrier block. The boundary is determined by a central portion between a first end portion of the flat portion in an N-th right-eye crosstalk distribution corresponding to an N-th barrier-shift mode and an end portion of the flat portion in an (N+1)-th left-eye crosstalk distribution corresponding to an (N+1)-th barrier-shift mode. The (N+1)-th barrier-shift mode includes the barrier part shifted toward the first side by one bather electrode with respect to the barrier part of the N-th barrier-shift mode.

For example, as shown in FIG. 16, a first boundary C1 is determined by a central portion between a first end portion of the flat portion RC2_S in a second right-eye crosstalk distribution RC2 and an end portion LC3_E of the flat portion in a third left-eye crosstalk distribution LC3. A second boundary C2 is determined by a central portion between a first end portion of the flat portion RC1_S in a first right-eye crosstalk distribution RC1 and an end portion LC2_E of the flat portion in a second left-eye crosstalk distribution LC2. A third boundary C3 is determined by a central portion between a first end portion of the flat portion RC12_S in a twelfth right-eye crosstalk distribution RC12 and an end portion LC1_E of the flat portion in a first left-eye crosstalk distribution LC1. A fourth boundary C4 is determined by a central portion between a first end portion of the flat portion RC11_S in an eleventh right-eye crosstalk distribution RC11 and an end portion LC12_E of the flat portion in a twelfth left-eye crosstalk distribution LC12.

The barrier control part 600 divides the active area AA of the active bather panel 500 into first, second, third, fourth and fifth barrier blocks BB1, BB2, BB3, BB4 and BB5 based on the first to fourth boundaries C1, C2, C3 and C4.

The barrier control part 600 determines the barrier-shift mode for every barrier block so that the flat portions of the left-eye and right-eye crosstalk distributions are maintained.

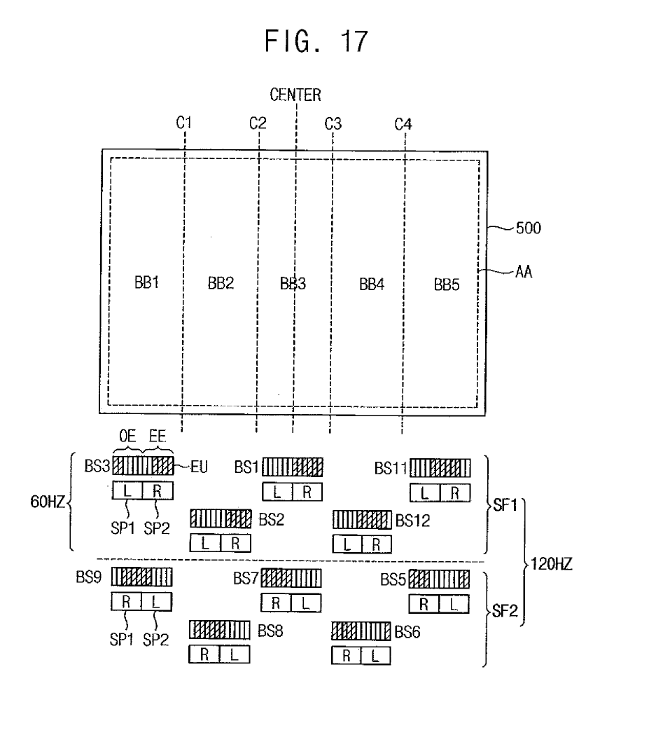

As shown in FIG. 17, the first barrier block BB1 is determined as the third barrier-shift mode BS3, the second barrier block BB2 is determined as the second barrier-shift mode BS2, the third barrier block BB3 is determined as the first barrier-shift mode BS1, the fourth barrier block BB4 is determined as the twelfth barrier-shift mode BS12, and the fifth barrier block BB5 is determined as the eleventh barrier-shift mode BS11.

When the observer's view distance is more than the OVD, the barrier-shift modes of a left-side with respect to the center area O of the active barrier panel 500 are increased by one step in a preceding direction from the center area CENTER to a left edge, in order, as the first, second and third barrier-shift modes BS1 BS2 and BS3. The third barrier block BB3 including the center area O has the first barrier-shift mode BS1, the second barrier block BB2 which is located toward the left-side with respect to the third barrier block BB3 has the second barrier-shift mode BS2 increased by one step from the first barrier-shift mode BS1 and the first barrier block BB1 which is located toward the left-side with respect to the second barrier block BB2 has the third barrier-shift mode BS3 increased by one step from the second barrier-shift mode BS2. In addition, the fourth barrier block BB4 which is located toward the right-side with respect to the third barrier block BB3 has the twelfth barrier-shift mode BS12 decreased by one step from the first barrier-shift mode BS1 and the fifth barrier block BB5 which is located toward the right-side with respect to the fourth barrier block BB4 has the eleventh barrier-shift mode BS11 decreased by one step from the twelfth barrier-shift mode BS12. Therefore, the barrier blocks BB1, BB2, BB3, BB4 and BB5 may have the barrier-shift modes BS3, BS2, BS1, BS12 and BS11 decreased by one step.

FIG. 17 is a conceptual diagram illustrating a method of driving the active barrier panel by the barrier control part shown in FIG. 16 according to an exemplary embodiment of the inventive concept.

Referring to FIGS. 1 and 17, the barrier control part 600 controls the barrier driving part 700 based on the barrier-shift mode determined by every barrier block.

The barrier driving part 700 provides the bather electrodes in the electrode unit with driving voltages based on the barrier-shift mode. First driving voltages are applied to the barrier electrodes operating as the opening part and second driving voltages are applied to the barrier electrodes operating as the barrier part. For example, the barrier driving part 700 provides the barrier electrodes in the even-numbered electrode part EE with the driving voltages which are opposite to the driving voltage applied to the barrier electrodes in the odd-numbered electrode part OE.

The first sub-pixel SP1 of the display panel corresponding to the odd-numbered electrode part OE displays the left-eye image L and the second sub-pixel SP2 of the display panel corresponding to the even-numbered electrode part EE displays the right-eye image R.

Each of the barrier blocks of the active barrier panel 500 is operated in the determined barrier-shift mode. As shown in FIG. 17, the electrode unit EU in the first barrier block BB1 is operated in the third barrier-shift mode BS3, the electrode unit EU in the second barrier block BB2 is operated in the second barrier-shift mode BS2, the electrode unit EU in the third barrier block BB3 is operated in the first barrier-shift mode BS1, the electrode unit EU in the fourth barrier block BB4 is operated in the twelfth barrier-shift mode BS12 and the electrode unit EU in the fifth barrier block BB5 is operated in the eleventh barrier-shift mode BS11.

Therefore, the observer may observe a 3D image having a minimum crosstalk at a view distance greater than the OVD.

As described above, the display panel and the active barrier panel may be driven at frame frequency of about 60 Hz, but the invention is not limited thereto. In an exemplary embodiment, the display panel and the active barrier panel are driven at a frame frequency of about 120 Hz so that a resolution of the 3D image is substantially the same as that of the 2D image.

For example, during a first sub frame SF1, the display panel and the active barrier panel may be driven using the barrier-shift modes described above.

Then, during a second sub frame SF2, the first and second sub-pixels SP1 and SP2 display the images opposite to the left-eye and right-eye images L and R respectively displayed on the first and second sub-pixels SP1 and SP2 during the first sub frame SF1. Thus, the first sub-pixel SP1 displays the right-eye image R and the second sub-pixel SP2 displays the left-eye image.

In addition, during a second sub frame SF2, each of the barrier blocks of the active barrier panel 500 is operated in the barrier-shift modes opposite to the barrier-shift modes in the first sub frame SF1. During the second sub frame, the barrier electrodes operated as the opening part in the first sub frame SF1, are operated as the barrier part and the barrier electrodes operated as the barrier part in the first sub frame SF1, are operated as the opening part.

Thus, during the second sub frame SF2, the first barrier block BB1 is operated in the ninth barrier-shift mode BS9 opposite to the third barrier-shift mode BS3, the second barrier block BB2 is operated in the eighth barrier-shift mode BS8 opposite to the second barrier-shift mode BS2, the third barrier block BB3 is operated in the seventh barrier-shift mode BS7 opposite to the first barrier-shift mode BS1, the fourth barrier block BB4 is operated in the sixth barrier-shift mode BS6 opposite to the twelfth barrier-shift mode BS12, and the fifth barrier block BB5 is operated in the fifth bather-shift mode BS5 opposite to the eleventh barrier-shift mode BS11.

Therefore, the observer may observe a 3D image having a minimum crosstalk at a view distance less than the OVD. In addition, the display panel and the active barrier panel may be driven at the frame frequency of about 120 Hz so that the 3D image may have the resolution of the 2D image.

Although, not shown in figures, when the observer's movement position shifted toward the horizontal direction along the view distance greater than the OVD is outside the viewing area VA, the boundary of the barrier block is shifted based on the observer's movement position and the active barrier panel is driven based on the shifted boundary, such as described referring to FIGS. 11 to 14.

According to at least one exemplary embodiment of the present invention, the barrier block of the active barrier panel and the barrier-shift mode corresponding to the barrier block are determined according to the observer's position, for example, the view distance with respect to the OVD and the active barrier panel is driven using the barrier-shift mode. Therefore, the flat portion in the left-eye and right-eye crosstalk distributions is maintained so that the observer's optimum view distance may be extended.

The foregoing is illustrative of the present invention and is not to be construed as limiting thereof. Although a few exemplary embodiments of the present invention have been described herein, those skilled in the art will readily appreciate that many modifications are possible in these exemplary embodiments without materially departing from the present invention. Accordingly, all such modifications are intended to be included within the scope of the present invention.

What is claimed is:

1. A method of driving an active barrier panel, the active barrier panel comprising an electrode unit which has n barrier electrodes operating as an opening part transmitting light and n barrier electrodes operating as a barrier part blocking the light, the method comprising:
calculating a crosstalk distribution of each of observer's left-eye and right-eye corresponding to each of 2n barrier-shift modes, according to an observer's position;
dividing an active area of the active barrier panel into at least one barrier block based on a flat portion of the crosstalk distribution, in which a minimum crosstalk is maintained;
determining the barrier-shift mode for each barrier block to maintain the minimum crosstalk; and
operating the electrode unit in a corresponding barrier block in the determined barrier-shift mode,
wherein n is a natural number.

2. The method of claim 1, wherein the dividing the active area comprises:
determining a central portion between a first end portion of the flat portion in a right-eye crosstalk distribution and a second end portion of the flat portion in a left-eye crosstalk distribution, as a boundary of the bather block, when an observer's view distance is outside an optimum view distance (“OVD”), the observer' view distance being a straight distance between an observer's position and the active barrier panel.

3. The method of claim 2, wherein when the observer' view distance is less than the OVD, a central portion between a first end portion of the flat portion in a right-eye crosstalk distribution corresponding to an N-th barrier-shift mode and a second end portion of the flat portion in a left-eye crosstalk distribution corresponding to an (N−1)-th barrier-shift mode, is determined as a boundary of the barrier block, wherein the N-th barrier-shift mode includes the barrier part shifted toward a first side by one barrier electrode with respect to the barrier part of the (N−1)-th barrier-shift mode.

4. The method of claim 3, wherein when the observer' view distance is more than the OVD, a central portion between a first end portion of the flat portion in a right-eye crosstalk distribution corresponding to the N-th barrier-shift mode and a second end portion of the flat portion in a left-eye crosstalk distribution corresponding to an (N+1)-th barrier-shift mode, is determined as a boundary of the barrier block, wherein the (N+1)-th barrier-shift mode includes the barrier part shifted toward the first side by one barrier electrode with respect to the barrier part of the N-th barrier-shift mode.

5. The method of claim 4, wherein when the observer' view distance is less than the OVD,
the barrier blocks which are arranged in a preceding direction from the first side to a second side, are respectively operated in the barrier-shift modes including the barrier parts sequentially shifted toward the second side by one barrier electrode.

6. The method of claim 4, wherein when the observer' view distance is greater than the OVD,
the barrier blocks which are arranged in a preceding direction from the first side to the second side, are respectively operated in the barrier-shift modes including the barrier parts sequentially shifted toward the first side by one barrier electrode.

7. The method of claim 2, wherein a viewing area is defined by a first end portion of the flat portion in a right-eye crosstalk distribution and a second end portion of the flat portion in a left-eye crosstalk distribution, and
when the number of the barrier electrodes in the electrode unit is increased, the viewing area is increased.

8. The method of claim 7, wherein a width of the electrode unit is less than the viewing area.

9. The method of claim 7, wherein a width of the electrode unit corresponds to a period of a sub-pixel displaying the left-eye image or the right-eye image.

10. The method of claim 2, further comprising:
shifting the boundary of the barrier block according to the observer's position, when the observer's position is shifted in a horizontal direction.

11. The method of claim 1, wherein the n is equal to or greater than six.

12. A display apparatus comprising:
a display panel including a plurality of sub-pixels;
an active barrier panel disposed adjacent the display panel and including an electrode unit which includes n barrier electrodes configured to operate as an opening part to transmit light and n barrier electrodes configured to operate as a barrier part to block the light; and
a barrier control part configured to calculate a crosstalk distribution of each of observer's left-eye and right-eye corresponding to each of 2n barrier-shift modes, according to an observer's position, divide an active area of the active barrier panel into at least one barrier block based on a flat portion of the crosstalk distribution, in which a minimum crosstalk is maintained, and determine the barrier-shift mode for each barrier block to maintain the minimum crosstalk,
wherein n is a natural number.

13. The display apparatus of claim 12, wherein the barrier control part determines a central portion between a first end portion of the flat portion in a right-eye crosstalk distribution and a second end portion of the flat portion in a left-eye crosstalk distribution, as a boundary of the barrier block, when an observer's view distance is outside an optimum view distance (“OVD”), wherein the observer' view distance is a straight distance between an observer's position and the active barrier panel.

14. The display apparatus of claim 13, wherein when the observer' view distance is less than the OVD, the barrier control part determines a central portion between a first end portion of the flat portion in a right-eye crosstalk distribution corresponding to an N-th barrier-shift mode and a second end portion of the flat portion in a left-eye crosstalk distribution corresponding to an (N−1)-th barrier-shift mode, as a boundary of the barrier block,
wherein the N-th barrier-shift mode includes the barrier part shifted toward a first side by one barrier electrode with respect to the barrier part of the (N−1)-th barrier-shift mode.

15. The display apparatus of claim 14, wherein when the observer' view distance is more than the OVD, the barrier control part determines a central portion between a first end portion of the flat portion in a right-eye crosstalk distribution corresponding to the N-th barrier-shift mode and a second end portion of the flat portion in a left-eye crosstalk distribution corresponding to an (N+1)-th barrier-shift mode, as a boundary of the barrier block,
wherein the (N+1)-th barrier-shift mode includes the barrier part shifted toward the first side by one barrier electrode with respect to the barrier part of the N-th barrier-shift mode.

16. The display apparatus of claim 15, wherein when the observer' view distance is less than the OVD,
the barrier blocks which are arranged in a preceding direction from the first side to the second side, are respectively operated as the barrier-shift modes including the barrier parts sequentially shifted toward the second side by one barrier electrode.

17. The display apparatus of claim 15, wherein when the observer' view distance is more than the OVD,
the barrier blocks which are arranged in a preceding direction from the first side to the second side, are respectively operated as the barrier-shift modes including the barrier parts sequentially shifted toward the first side by one barrier electrode.

18. The display apparatus of claim 13, wherein a viewing area is defined by a first end portion of the flat portion in a right-eye crosstalk distribution and a second end portion of the flat portion in a left-eye crosstalk distribution, and
when the viewing area is determined by the number of the barrier electrodes in the electrode unit.

19. The display apparatus of claim 18, wherein when the number of the barrier electrodes in the electrode unit is increased, the viewing area is increased.

20. The display apparatus of claim 18, wherein a width of the electrode unit is less than the viewing area.

21. The display apparatus of claim 18, wherein a width of the electrode unit corresponds a period of a sub-pixel displaying the left-eye image or the right-eye image.

22. The display apparatus of claim 21, wherein when a width of the electrode unit corresponds to two sub-pixels, a first sub-pixel displays the left-eye image and a second sub-pixel adjacent the first sub-pixel in a horizontal direction displays the right-eye image.

23. The display apparatus of claim 13, wherein when the observer's position is shifted in a horizontal direction, the barrier control part shifts the boundary of the barrier block in the horizontal direction according to the observer's position.

24. The display apparatus of claim 12, wherein the n is equal to or greater than six.

25. The display apparatus of claim 12, wherein the active barrier panel includes a plurality of driving units, each of the driving units includes at least one electrode unit, and the barrier electrodes in the driving unit are driven together.

26. The display apparatus of claim 12, wherein during a first sub frame, first and second sub-pixels of the display panel respectively display a left-eye image and a right-eye image and the barrier block of the active barrier panel operates as the opening part and the barrier part based on the determined barrier-shift mode, and
during a second sub frame, the first and second sub-pixels of the display panel respectively display images opposite to those displayed on the first and second sub-pixels during the first sub frame, and the barrier block of the active barrier panel operates as the opening part and the barrier part opposite to those operated during the first sub frame.

27. A display apparatus comprising:
a display panel including a plurality of pixels, wherein each pixel comprises a pair of sub-pixels;
an active barrier panel disposed adjacent the display panel and comprising n barrier electrodes configured to operate as an opening part to transmit light and n barrier electrodes configured to operate as a barrier part to block the light;
a control part configured to generate a signal indicating a distance an observer is located away from the active barrier panel;
a barrier control part configured to predict a left-eye and right-eye crosstalk distribution that would be experienced by the observer moving horizontally along the distance for each of 2n barrier-shift modes, divide the active barrier panel into barrier blocks, and drive each barrier block according to a selected one of the barrier-shift modes that provides a minimum corresponding crosstalk based on the predicted cross talk distributions,
wherein n is a natural number.

28. The display apparatus of claim 27, wherein the crosstalk is the minimum in flat portions of the left-eye and right-eye crosstalk distribution for one of the barrier-shift modes.

29. The display apparatus of claim 28, wherein a boundary of one of the barrier blocks is a central portion between a first end portion of the flat portion in the right-eye crosstalk distribution of the one barrier-shift mode and a second end portion of the flat portion in the left-eye crosstalk distribution of the one barrier-shift mode.
